(19) United States
(12) Patent Application Publication
(10) Pub. No.: US 2011/0055238 A1
(43) Pub. Date: Mar. 3, 2011

(54) METHODS AND SYSTEMS FOR GENERATING NON-OVERLAPPING FACETS FOR A QUERY

(75) Inventors: Malcolm Slaney, Palo Alto, CA (US); Aaron Wheeler, San Francisco, CA (US)

(73) Assignee: Yahoo! Inc., Sunnyvale, CA (US)

(21) Appl. No.: 12/550,126

(22) Filed: Aug. 28, 2009

(51) Int. Cl. G06F 17/30

(52) U.S. Cl. 707/759; 707/E17.017

(57) ABSTRACT

Methods and systems are disclosed for generating non-overlapping facets for an original query that is submitted for a search.

### BACKGROUND

1. Field

The subject matter disclosed herein relates to methods and systems for generating non-overlapping facets for an original query that is submitted by a user for a search.

2. Information

The rate at which information is created in the world today continues to increase. There is personal and professional information, public and private information, entertainment and scientific information, governmental information, and so forth. There is so much information that organizing and accessing it can become problematic. Various approaches to data processing strive to overcome such problems.

Data processing tools and techniques continue to evolve. The different evolutions attempt to address how information in the form of data is continually being created or otherwise identified, collected, stored, shared, and/or analyzed. Databases and data repositories generally are commonly employed to contain a collection of information. Communication networks and computing device resources can provide access to the information stored in such data repositories. Moreover, communication networks themselves can become data repositories.

An example communication network is the “Internet,” which has become ubiquitous as a source of and repository for information. The “World Wide Web” (WWW) is a portion of the Internet, and it too continues to grow, with new information seemingly being added constantly. To provide access to information that is located in and/or that is accessible via such communication networks, tools and services are often provided that facilitate the searching of great amounts of information in a relatively efficient manner. For example, service providers may enable users to search the WWW or another (e.g., local, wide-area, distributed, etc.) communication network using one or more so-called search engines. Similar and/or analogous tools or services may enable one or more relatively localized data repositories to be searched.

Via the WWW for example, a tremendous variety of different types of information is available. So-called “web documents” may contain text, images, videos, interactive content, combinations thereof, and so forth. Web documents can be formulated in accordance with a variety of different formats. Example formats include, but are not limited to, a HyperText Markup Language (HTML) document, an Extensible Markup Language (XML) document, a Portable Format Document (PDF) document, H.264/AVC media-capable document, combinations thereof, and so forth. Thus, unless specifically stated otherwise, a “web document” as used herein may refer to source code, associated data, a file accessible or identifiable through the WWW (e.g., via a search), some combination of these, and so forth, just to name a few examples. Regardless of the format and/or content of web documents, search tools and services attempt to provide access to desired web documents through a search engine.

Access to search engines, such as those provided by YAHOO!® ( (e.g., via “yahoo[dot]com”), is usually enabled through a search interface of a search service. (“Search engine”, “search provider”, “search service”, “search interface”, etc. are sometimes used interchangeably, depending on the context.) In an example operative interaction with a search interface, a user typically submits a query. In response to the submitted query, a search engine returns multiple search results that are considered relevant to the query in some manner. To facilitate access to the information that is potentially desired by the user, the search service usually ranks the multiple search results in accordance with an expected relevancy to the user based on the submitted query, and possibly based on other information as well.

However, with so much information being available via different data repositories and/or communications networks, such as the WWW, there is a continuing need to refine the search ecosystem to better help a user access the information that he or she is looking for. In short, there is an ongoing need for methods and systems that enable relevant information to be identified and presented in an efficient and comprehendible manner.

### BRIEF DESCRIPTION OF DRAWINGS

Non-limiting and non-exhaustive aspects are described with reference to the following figures, wherein like reference numerals refer to like parts throughout the various figures, unless otherwise specified.

FIG. 1 is a block diagram of an example search paradigm in which a search analysis produces search results information for facets as well as search results information for an original query according to an embodiment.

FIG. 2 depicts an example user interface that displays search results information for facets and search results information for an original query according to an embodiment.

FIG. 3 is a schematic block diagram of systems, devices, and/or resources of an example computing environment, including an information integration system that is capable of performing a search analysis according to an embodiment.

FIG. 4 is a flow diagram that illustrates an example method involving two devices and pertaining to the generation of non-overlapping facets at a second device for an original query that is submitted at a first device according to an embodiment.

FIG. 5 is a block diagram showing an example application of an original query to one or more data sources to ascertain multiple expansion queries according to an embodiment.

FIG. 6 is a block diagram showing an example application of multiple expansion queries to an information collection to determine the numbers of search results that are associated with the multiple expansion queries according to an embodiment.

FIG. 7 is a block diagram showing an example generation of a grouping of non-overlapping facets from multiple identified facet candidates that are associated with multiple expansion queries according to an embodiment.

FIG. 8 is graphical diagram depicting an example generation of multiple non-overlapping facets according to an embodiment.

FIG. 9 is a flow diagram that illustrates an example method for generating multiple non-overlapping facets from identified facet candidates according to an embodiment.

FIG. 10 is a flow diagram that illustrates an example method for determining if a facet candidate is to be excluded from a grouping of non-overlapping facets based on a predetermined size threshold according to an embodiment.

FIG. 11 is a block diagram of example devices that may be configured into special purpose computing devices that implement aspects of one or more of the embodiments that are described herein for generating non-overlapping facets for an original query according to an embodiment.

### DETAILED DESCRIPTION

In the following Detailed Description, numerous specific details are set forth to provide a thorough understanding of claimed subject matter. However, it will be understood by those skilled in the art that claimed subject matter may be practiced without these specific details. In other instances, methods, apparatuses, systems, and technologies generally that would be known by a person of ordinary skill in the art have not been described in detail so as not to obscure claimed subject matter.

As noted above, there is an ongoing need for methods and systems that enable relevant information to be identified and presented in an efficient and comprehendible manner so as to help a user access information that he or she is looking for. Certain example embodiments that are described herein relate to an electronically-realized search service that is capable of encouraging diversity in search results and partitioning/organizing such search results into facets so that a user can more easily understand the types of results and/or content that may be accessed.

Thus, search results may be organized/partitioned so that users can more easily find those search results in which they are interested. Finding and providing relevant search results can be particularly problematic for relatively broad queries. For example, there are many different aspects to the search results for a broad query such as “San Francisco”. In a web-page search, it may be possible to find one web page that describes each of the desired aspects of San Francisco. On the other hand, this tends not to be true for multimedia objects—e.g., each picture would likely show just one portion of San Francisco. It can therefore be informative to a user if the available search results are organized/partitioned so that different aspects of the query are presented separately. As used herein to facilitate understanding, such different aspects are termed facets. Hence, each facet may describe and/or relate to a different aspect of the query. Two facets may be considered substantially non-overlapping if the contents of a first facet have little or no overlap with the contents of a second facet. This non-overlapping aspect of facet generation may be relatively easy to accomplish if the clustering of the search results is based on geography, because pictures of two neighborhoods are unlikely to overlap. The problem can be more difficult, however, with other kinds of search result objects. Yet there might be acceptable overlap if one facet for, e.g., New York City has pictures of Times Square while another facet has night-time shots of the city.

In certain example embodiments, multiple non-overlapping facets are generated for an original query that has been submitted for a search. The original query is associated with a set of search results. A facet may be associated with a subset of search results that are drawn from the set of search results for the original query. A particular facet may correspond to an expansion query that is ascertained based, for instance, on the original query. Moreover, the facets may be generated so as to comprise non-overlapping facets (or substantially non-overlapping facets). A non-overlapping facet may be a subset of search results that is disjoint with respect to the subsets of other non-overlapping facets. It should be noted, however, that in real-world implementations a given non-overlapping facet may not be completely disjoint with respect to every other non-overlapping facet. A task of generating multiple such non-overlapping facets from a set of search results associated with the original query may be addressed using, e.g., a maximum set coverage scheme.

Example embodiments are applicable to search targets generally, such as web documents, files of any type, combinations thereof, and so forth. However, an example implementation for non-overlapping facets is described here in the context of image items having image properties and where a maximum set coverage scheme is implemented using an example greedy algorithm. Thus, a grouping of non-overlapping facets is to be generated from a set of image items to provide insight as to the types of image search results that are available from the set of image items. Given a set of such image items, a first image property that occurs the most frequently is determined (e.g., the most popular facet may be determined). This most-frequently-occurring first image property is designated as a first non-overlapping facet.

Next, the remaining images in the set of images that are not in the first facet are considered so as to find a non-overlapping facet. From among these remaining, or current set of, image items, a second image property that occurs the most frequently is again determined. This second image property is designated as the second non-overlapping facet. This process of (i) taking the remaining images and (ii) collecting those that share the most-frequently-occurring remaining image property into another non-overlapping facet may be continued until the original set of image items, or some portion thereof, has been partitioned into multiple non-overlapping facets.

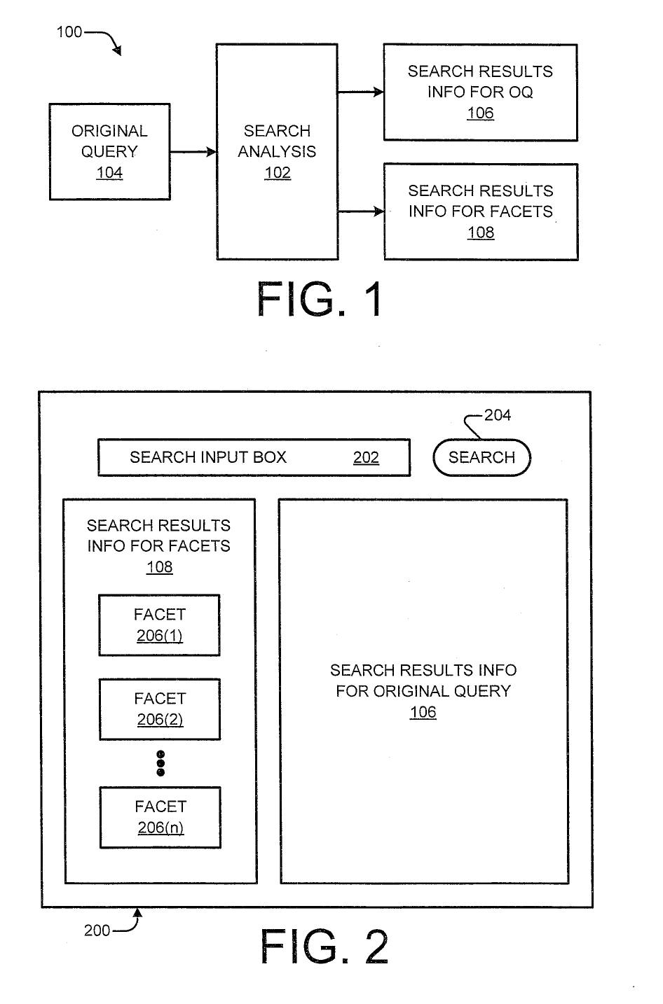

FIG. 1 is a block diagram of an example search paradigm 100 in which a search analysis 102 produces search results information for facets 108 as well as search results information for an original query 106. As illustrated, search paradigm 100 therefore includes search analysis 102, original query (OQ) 104, and search results information 106 and 108. However, search paradigm 100 may involve alternative and/or additional aspects without deviating from claimed subject matter.

In an example embodiment, original query 104 may be provided by a user (not shown in FIG. 1). Original query 104 may be applied as part of search analysis 102. Search analysis 102 may produce search results information associated with an original query 106 and search results information for facets 108. Search results information 106 may comprise a list of search results that are associated with original query 104. Search results information 106 may include, for instance, one or more individual search results that are considered relevant to original query 104.

Search results information for facets 108 may be at least partially related to original query 104. Search results information 108 may include, for example, one or more facets that reveal knowledge about information that is related to original query 104 and may be available in conjunction with a search procedure of some kind. In example implementations, a facet may correspond to a potential value (e.g., a word or words, a description or descriptions, a property or properties, etc.) that is common to a number of objects, such as a number of search results and/or the items that they represent. Facets may at least partially partition an overall group of search results into multiple search result collections that share some kind or kinds of commonality. The facets may convey to a user what types of content, what types of information, what types of items, etc. that are related to the original query may be available through a search procedure.

Facets may vary based on an original query and/or a group of search results that are considered relevant thereto. Facets may also differ for the same original query for submissions by different users, for submissions at different times, for submissions targeting different items (e.g., different databases, networks, etc.) and so forth, just to name a few examples. By way of example, facets for an original query that includes a state name may include different city names and/or geographical areas of the named state. Alternatively, facets for a state name query may include “Cities”, “Professional Sports Teams”, “Weather”, “History”, “Government”, “Shopping”, and so forth, just to name a few examples that pertain to the named state. Example facets for a celebrity name query may include “Latest Gossip”, “Movie Roles Information”, “Fan Web Sites”, “Biographical Information”, “Red Carpet Photos”, and so forth, just to name a few examples. A specific hypothetical example of facet partitioning for a “San Francisco” original query is presented herein below. Generally, the available search results for original queries may be partitioned into many different facets without deviating from claimed subject matter.

FIG. 2 depicts an example user interface 200 displaying search results information for facets 108 and search results information for an original query 106 according to a particular embodiment. As illustrated, user interface 200 includes a search input box 202 and a search button 204, in addition to search results information for an original query 106 and search results information for facets 108. Search results information for facets 108 includes multiple facets 206. Specifically, “n” facets 206(1), 206(2) . . . 206(n) are shown, with “n” representing a positive integer. Although a specific example layout is shown, the layout of user interface 200 may differ. Also, the information content of user interface 200 may differ from that which is shown and described below without deviating from claimed subject matter.

In an example embodiment, user interface 200 is displayed for a user on a display screen of a user device (not shown in FIG. 2). Search input box 202 allows the user to submit an original query (e.g., using alphanumeric characters). Search button 204 enables the user to activate a search and/or command that a search be undertaken, such as a search analysis 102 (of FIG. 1). In the illustrated context, a search has already been performed and search results information 106 and 108 are being displayed. By way of example but not limitation, a listing of the top (e.g., 10) search results (not explicitly shown) that are considered relevant to the original query are presented as part of search results information for an original query 106.

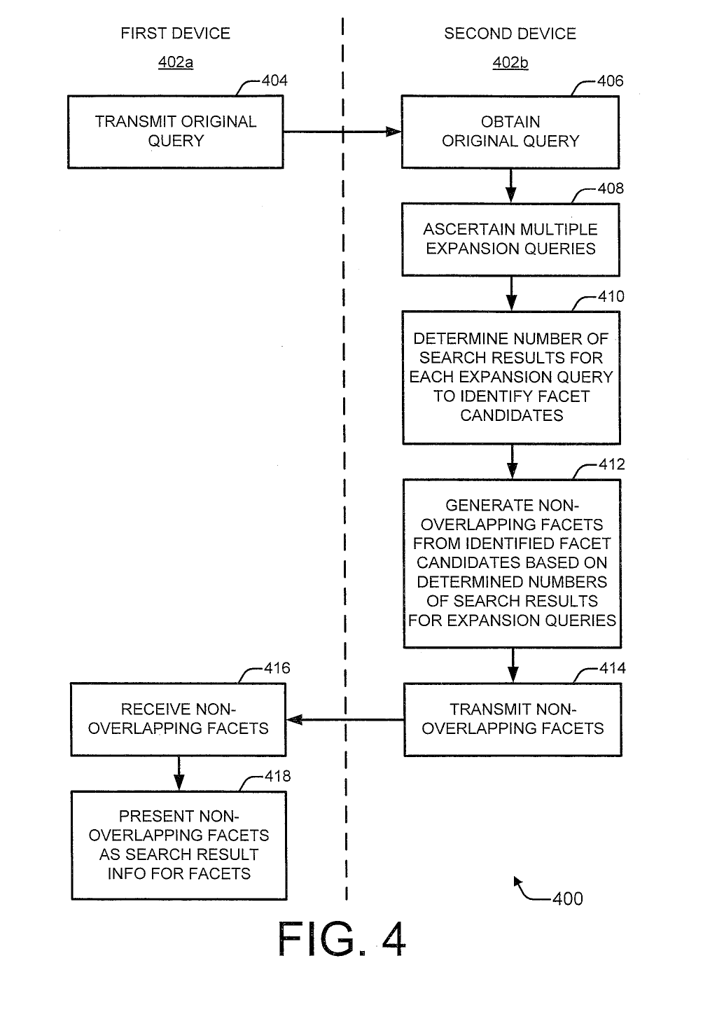

Also by way of example but not limitation, a listing of the top “n” facets 206 are presented as part of search results information for facets 108. In an example implementation, the displayed “n” facets 206 are at least partially related to the original query. For certain example embodiments, facets 206 that are presented as part of search results information for facets 108 may be generated from identified facet candidates so as to be non-overlapping facets. This is described further herein below with particular reference to FIGS. 4-9 according to particular example implementations.

A hypothetical example is provided below to further illuminate certain example principles for facets 206. In this hypothetical example, an original query 104 is “San Francisco”. “San Francisco” is subjected to a search analysis (e.g., with regard to a set of image items), and a number of search results that are considered most relevant, using any of numerous different search strategies and/or ranking schemes, are presented as part of search results information for an original query 106. At least a portion of the total search results (e.g., 20) that are considered relevant to “San Francisco” are also separated into identified facets.

The resulting identified facet candidates for this hypothetical “San Francisco” example are: “Golden Gate Bridge”, “Alcatraz”, “Pier 39”, and “Lombard Street”. These four facet candidates partition the total search results for “San Francisco” into four facets 206. The facets may indicate to a user other possible topics, categories, subjects, etc. that may be related to the original query that is submitted and/or the search results thereof. In an example implementation, each facet 206 may be displayed as part of user interface 200 in proximity to a numerical element that conveys the number of search results that are associated therewith.

For the hypothetical “San Francisco” example, “Golden Gate Bridge” may be associated with ten search results, “Alcatraz” may be associated with seven search results, “Pier 39” may be associated with six search results, and “Lombard Street” may be associated with four search results. (If the search results are extracted from a relatively large information collection such as the WWW, the number of search results will typically be much higher—e.g., thousands, hundreds of thousands, or more.) Thus, if “duplicate” search results are permitted to persist in a facet, facet 206(1) would read “Golden Gate Bridge—10”, and facet 206(2) would read “Alcatraz—7”. Facet 206(3) (not explicitly shown) would read “Pier 39—6”, and facet 206(4) (not explicitly shown) would read “Lombard Street—4”.

As noted herein above and described further herein below, in accordance with certain embodiments, the search results associated with each facet 206 may be exclusive of other facets so that non-overlapping facets can be presented. Non-overlapping facets may be at least substantially disjoint with respect to one another after undergoing one or more attempts to remove duplicates and/or after implementing one or more strategies to prevent duplicates. However, it should be understood that duplicate removal/prevention may be imperfect. This is especially true if search results for an original query are acquired from multiple different information collections and/or if expansion queries are ascertained using multiple different data sources. Thus, substantially non-overlapping facets may be generated for a submitted original query. Substantially non-overlapping facets may imply the existence of some overlap. In other words, a relatively small percentage of search result(s) may inadvertently be duplicated across any two or more of the generated substantially non-overlapping facets. Such a relatively small percentage may comprise, by way of example but not limitation, a zero to five percent (0-5%) overlap, depending on the searched information collections and/or the considered data sources.

A user may interact with facets 206 of user interface 200 by selecting one or more of them sequentially or simultaneously. Selecting may be accomplished by clicking with a mouse, touching with a finger or stylus, activating voice commands, making gestures/motions, submitting keyboard input, “hovering over”, and so forth, just to name a few examples. If a facet 206 is selected, at least a portion of the search results associated with the selected facet may be presented. Such search results associated with a selected facet may be presented in a pop-up window or bubble, in a new window, in a new tab, in place of search results information for an original query 106, and so forth. The presented search results for the selected facet 206 may be ordered based on a relevancy ranking.

To create non-overlapping facets, “duplicate” search results may be removed. After “duplicate” search results are eliminated by generating such non-overlapping facets, the associated numbers of search results that may be displayed for each facet 206 differ. Thus, in a non-overlapping facet scenario, facet 206(1) may read “Golden Gate Bridge—7”, and facet 206(2) may read “Alcatraz—5”. Facet 206(3) (not explicitly shown) may read “Pier 39—3”, and facet 206(4) (not explicitly shown) may read “Lombard Street—2”. Example approaches to generating non-overlapping facets are described herein below. It should be understood that facets may be presented to a user in a myriad of manners that differ from those that are described herein and/or illustrated in FIG. 2 without deviating from claimed subject matter.

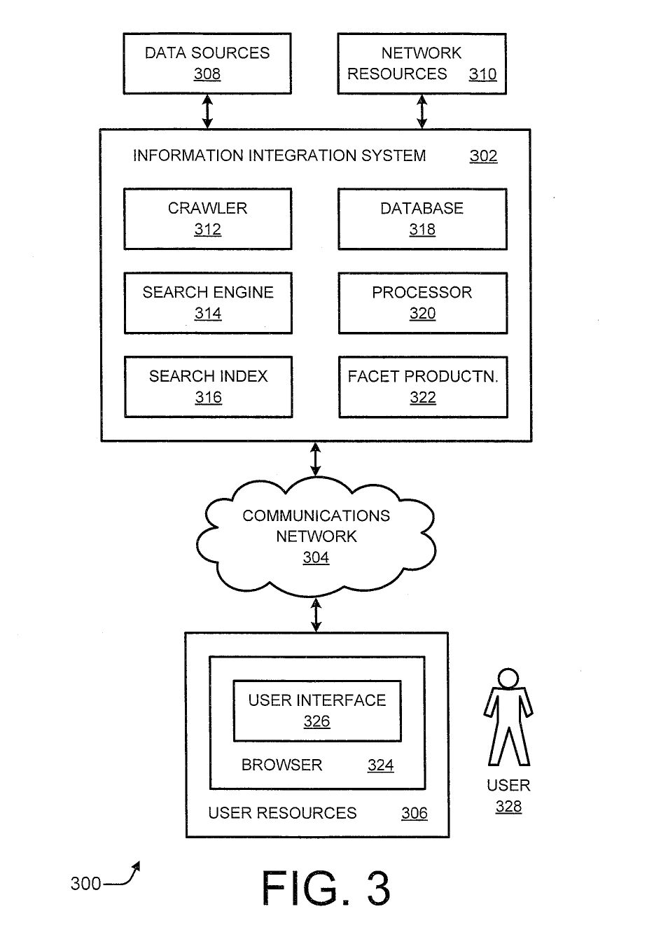

FIG. 3 is a schematic block diagram of systems, devices, and/or resources of an example computing environment 300, including an information integration system 302 that is capable of performing a search analysis. As illustrated, computing environment 300 includes information integration system 302, one or more communication network(s) 304, user resource(s) 306, data sources 308, network resources 310, and a user 328. Information integration system 302 includes a crawler 312, a search engine 314, a search index 316, a database 318, at least one processor 320, and facet production instructions 322. Although information integration system 302 is shown as including one each of elements 312-322, it may alternatively include more (or none) of such elements. User resources 306 include at least one browser 324, which may present user interface 326. Information integration system 302 and user resources 306 may alternatively include more, fewer, and/or different elements than those that are shown without deviating from claimed subject matter.

In example embodiments, information integration system 302 and user resources 306 may be in communication with one another via communication network 304. The context in which an information integration system 302 may be implemented may vary. By way of example but not limitation, an information integration system 302 may be implemented for public or private search engines, job portals, shopping search sites, travel search sites, RSS (Really Simple Syndication)-based applications and sites, combinations thereof, and so forth. In example implementations, information integration system 302 may be implemented in the context of a WWW search system. Also in certain example implementations, information integration system 302 may be implemented in the context of private enterprise networks (e.g., intranets) and/or at least one public network formed from multiple networks (e.g., the “Internet”). Information integration system 302 may also operate in other contexts, such as a local hard drive and/or home network.

As illustrated in FIG. 3, information integration system 302 may be operatively coupled to data sources 308 and to communications network 304. An end user 328 may communicate with information integration system 302 via communications network 304 using user resources 306. For example, user 328 may wish to search for web documents related to a certain topic of interest. User 328 may access a search engine website and submit a search query. User 328 may utilize user resources 306 to accomplish this search-related task. User resources 306 may comprise a computer (e.g., laptop, desktop, netbook, etc.), a personal digital assistant (PDA), a so-called smart phone with access to the Internet, a gaming machine (e.g., console, hand-held, etc.), an entertainment appliance (e.g., television, set-top box, e-book reader, etc.), a combination thereof, and so forth, just to name a few examples.

User resources 306 may permit a browser 324 to be executed thereon. Browser 324 may be utilized to view and/or otherwise access web documents from the Internet. A browser 324 may be a standalone application, an application that is embedded in or forms at least part of another program or operating system, and so forth. User 328 may provide an original query 104 to information integration system 302 over communication network 304 from browser 324 of user resources 306 and/or directly at information integration system 302 (e.g., bypassing communication network 304).

User resources 306 may also include and/or present a user interface 326, such as user interface 200 (of FIG. 2). User interface 326 may include, for example, an electronic display screen and/or various user input or output devices. User input devices include, for example, a microphone, a mouse, a keyboard, a pointing device, a touch screen, a gesture recognition system, combinations thereof, and so forth. Output devices include, for example, a display screen, speakers, tactile feedback/output systems, some combination thereof, and so forth. As shown by the example user interface 200 (of FIG. 2), user interface 326 may also comprise electrical digital signals representing the information that is presented or obtained via the output or input devices, respectively.

In an example operational scenario in a WWW context, user 328 may access a website for a search engine and submit an original query for a search. An original query 104 (of FIG. 1) may be transmitted from user resources 306 to information integration system 302 via communications network 304. In response, information integration system 302 may determine a list of web documents that is tailored based at least partly on relevance to the original query. Information integration system 302 may transmit such a list back to user resources 306 for display to user 328, for example, on user interface 326.

Generally, an information integration system 302 may include a crawler 312 to access network resources 310, which may include, for example, the Internet (e.g., the WWW) or other network(s), one or more servers, at least one data repository, combinations thereof, and so forth. Information integration system 302 may also include at least one database 318 and search engine 314 that is supported, for example, by search index 316. Information integration system 302 may further include one or more processors 320 and/or one or more controllers to implement various modules that comprise executable instructions. An example of processor-executable instructions is facet production instructions 322, which may generate non-overlapping facets when executed by a processor to thereby form a special purpose computing device. Facet production instructions 322 may be localized and executed on one device or distributed and executed on multiple devices. Facet production instructions 322 may also be at least partially executed by user resources 306 (e.g., as part of a “desktop” or local search tool).

In an example web-oriented implementation, crawler 312 may be adapted to locate web documents such as, for example, web documents associated with websites. Many different crawling algorithms are known and may be adopted by crawler 312. Crawler 312 may also follow one or more hyperlinks associated with a web document to locate other web documents. Upon locating a web document, crawler 312 may, for example, store the web document's uniform resource locator (URL) and/or other information from or about the web document in database 318 and/or search index 316. Crawler 312 may store, for instance, all or part of a web document's content (e.g., HTML or XML data, image data, embedded links, other objects, metadata, etc.) in database 318.

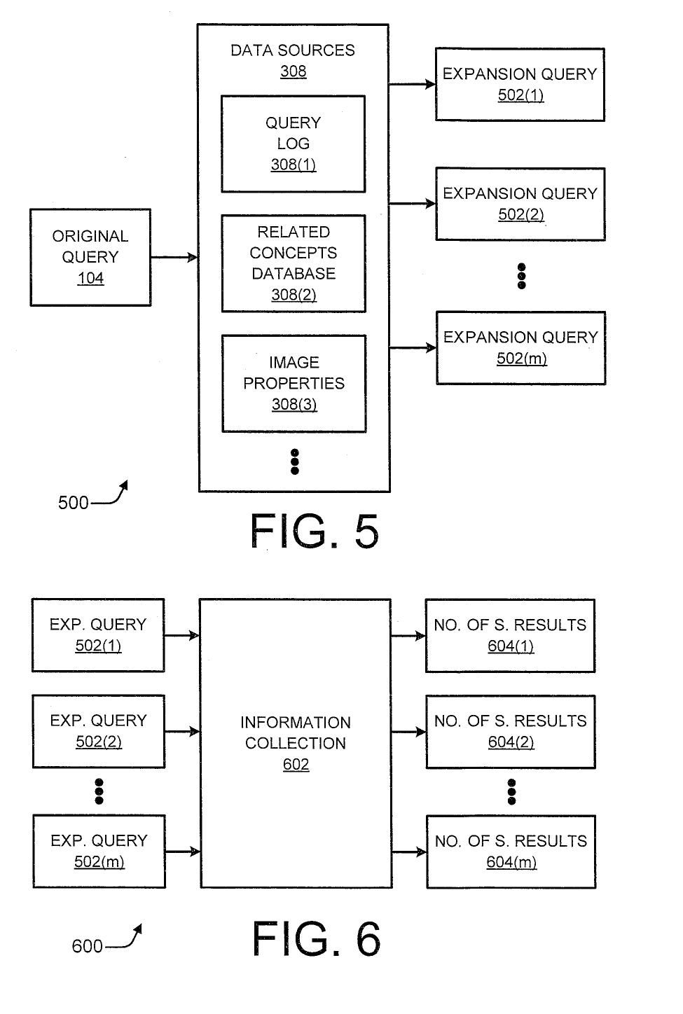

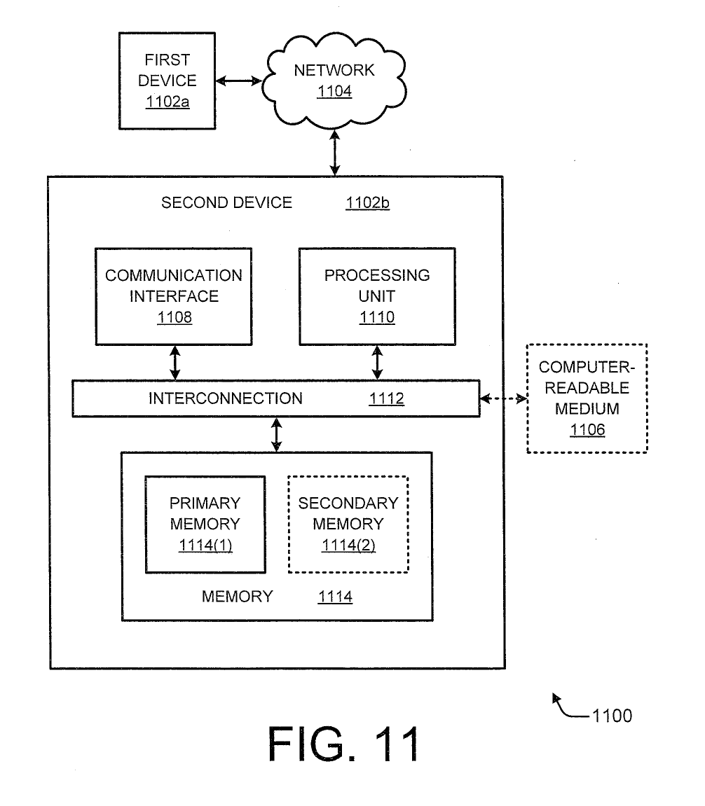

Upon receiving or otherwise obtaining an original query, information integration system 302 may also access one or more data sources 308 as part of a procedure for non-overlapping facet generation. The consideration of data sources 308 during the generation of non-overlapping facets is described further herein below with particular reference to FIGS. 4 and 5. Example device implementations for information integration system 302 and/or user resources 306 are described herein below with particular reference to FIG. 11 according to particular example implementations.

FIG. 4 is a flow diagram 400 illustrating an example method involving two devices and pertaining to the generation of non-overlapping facets at a second device for an original query that is submitted at a first device. As illustrated, flow diagram 400 includes eight operations 404-418. In the particular illustrated embodiment, these operations are performed by a first device 402a and a second device 402b. More specifically, operations 404, 416, and 418 may be performed by first device 402a, and operations 406-414 may be performed by second device 402b. Any of the operations may be partially or fully performed online (e.g., in real-time or near real-time while a user waits) or offline (e.g., before an original query arrives or otherwise while a user is not waiting for a response).

Initially, a user 328 (of FIG. 3) submits an original query 104 (of FIG. 1) at first device 402a. Original query 104 may be submitted via a search input box 202 of user interface 200 (both of FIG. 2). User 328 may then select search button 204. These acts may be accomplished using, for example, browser 324 and/or user resources 306. It should be noted that the submitting of the original query may alternatively be performed at second device 402b and that the operations of flow diagram 400 may be performed by a single device without deviating from claimed subject matter.

In an example embodiment, at operation 404, a first device transmits one or more signals representing an original query. For example, first device 402a may initiate transmission of first electrical digital signals (e.g., electrical, electromagnetic, etc. signals) representing an original query 104 toward second device 402b. At operation 406, the second device obtains the one or more signals representing the original query. For example, second device 402b may obtain first electrical digital signals that are representative of original query 104 as input by a user 328. For instance, second device 402b may obtain the original query by receiving it from first device 402a, by retrieving it from a memory and/or network location, by receiving it from a third device (not shown), some combination thereof, and so forth.

At operation 408, the second device ascertains multiple expansion queries that correspond to the original query. For example, second device 402b may ascertain multiple expansion queries corresponding to original query 104 using one or more data sources 308 (of FIG. 3). Example approaches to ascertaining multiple expansion queries using one or more data sources are described further herein below with particular reference to FIG. 5.

At operation 410, the second device determines a number of search results for each ascertained expansion query to identify facet candidates. For example, second device 402b may determine a number of search results that are associated with at least a portion of the multiple expansion queries with regard to at least one information collection to identify multiple facet candidates. Example approaches to determining numbers of search results for expansion queries so as to identify multiple facet candidates are described further herein below with particular reference to FIG. 6.

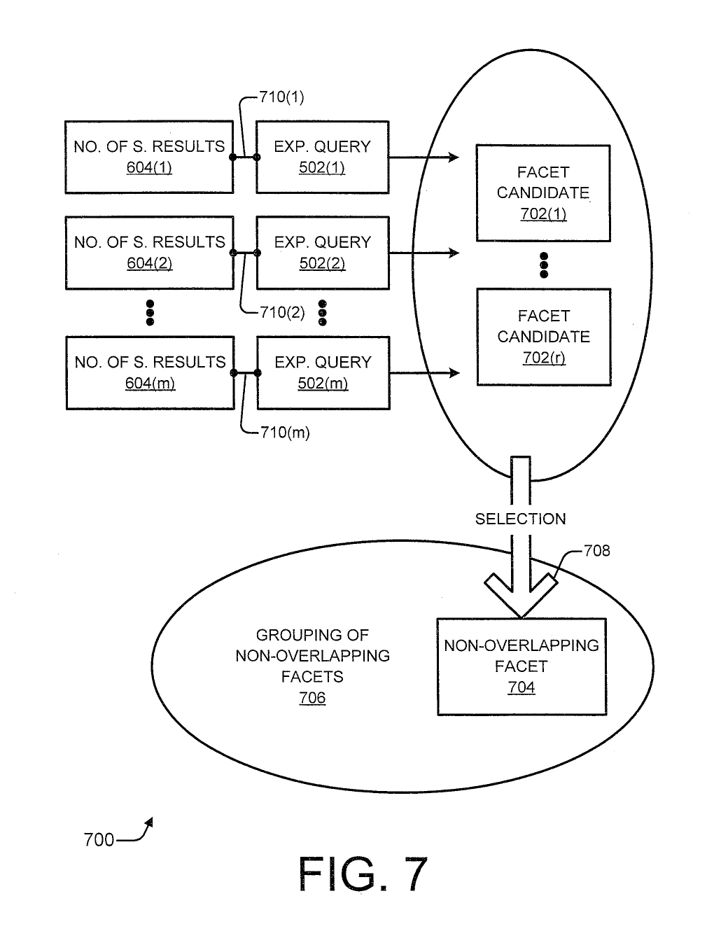

At operation 412, the second device generates non-overlapping facets from the identified facet candidates based on the determined numbers of search results for the ascertained expansion queries. For example, second device 402b may generate multiple non-overlapping facets for the original query from the multiple facet candidates based, at least in part, on the number of search results that are associated with the portion of the multiple expansion queries. Example approaches for generating multiple non-overlapping facets from the identified facet candidates are described further herein below with particular reference to FIGS. 7-9.

At operation 414, the second device transmits one or more signals representing the non-overlapping facets. For example, second device 402b may initiate transmission of second electrical digital signals representing the non-overlapping facets toward first device 402a. At operation 416, the first device receives the one or more signals representing the non-overlapping facets. For example, first device 402a may receive the second electrical digital signals representing the non-overlapping facets directly or indirectly (e.g., via third device) from second device 402b via one or more networks.

At operation 418, the first device presents the non-overlapping facets as search result information for facets. For example, first device 402a may display facets 206 (of FIG. 2) that are non-overlapping as part of search results information for facets 108 in user interface 200.

FIG. 5 is a block diagram showing an example application 500 of an original query 104 to one or more data sources 308 to ascertain multiple expansion queries 502. As illustrated, data sources 308 includes one or more data sources 308(1), 308(2), 308(3). . . . Although three data sources are shown as being part of data sources 308, more or fewer than three may alternatively be used. There are “m” expansion queries 502(1), 502(2) . . . 502(m), with “m” representing a positive integer.

In an example embodiment, original query 104 is applied to at least one data source 308 to ascertain one or more corresponding expansion queries 502. Expansion queries 502 may depend, at least partly, on the original terms of original query 104. Alternatively, some expansion queries 502 may be independent of original query 104. Such independent expansion queries may include other terms that are (e.g., automatically) tried with each original query, may be other terms that depend on a user's search history, may be other terms that depend on currently popular topics, combinations thereof, and so forth. Expansion queries 502 may include, by way of example but not limitation, suggested phrase completions, related terms, combinations thereof, and so forth. Common or so-called “stop” words (e.g., “the”, “a”, “hotel”, etc.) may be omitted from expansion queries 502.

Data sources 308 may be any data that provide additional information for an original query 104. Three example data sources 308(1,2,3) are explicitly described herein, but others may alternatively and/or additionally be employed. The outputs of any of these three data sources 308(1,2,3) may depend at least partially on the original terms of original query 104. None, one, or multiple expansion queries 502 may be ascertained from a single given data source 308.

A query log 308(1) typically includes multiple queries that have previously been received from (e.g., other) users. A query log 308(1) may indicate which kinds of specialized queries people use (e.g., commonly submit to a search engine). In an example implementation, if a previously-received query includes at least one of the original term(s) of original query 104, the previously-received query may be ascertained to be an expansion query 502 that corresponds to original query 104. Thus, one or more expansion queries 502 may include at least a portion of multiple queries from query log 308(1) that include at least one of the original terms of original query 104.

A related concepts database 308(2) typically includes multiple entries with each entry associating at least one first concept with at least one second concept. A related concepts database 308(2) may be, but is not necessarily, themed. For example, an entertainment/celebrity themed database may associate a particular actor with concepts (e.g., roles, paramours, movies, etc.) that are considered related thereto. A scientific themed database may associate a particular physics principle with concepts (e.g., applications/uses, corollaries, discoverer, etc.) that are considered related thereto. Other themes may include, but are not limited to, geography/locations, movies, education, news, combinations thereof, and so forth.

In an example implementation, if an entry in related concepts database 308(2) includes at least one of the original term(s) of original query 104, the associated concept or multiple associated concepts may be ascertained to be an expansion query 502 or multiple expansion queries 502, respectively, that correspond to original query 104. Thus, if a related concepts database 308(2) is considered, one or more expansion queries 502 may include at least a portion of one or more other terms, which are extracted from database entries. Depending on implementation, the extracted other terms may be combined with at least one original term from original query 104.

An image properties data source 308(3) includes information that effectively associates terms with image properties and/or associates image properties with individual image items. Image properties may comprise tags or keywords from a meta-data perspective. From a visual data perspective, image properties may be visual features. Thus, an information collection to be searched, to comport with such an image properties data source 308(3), may include multiple image items, with at least a portion of the multiple image items associated with one or more tag words and at least one visual feature.

Visual features may include, but are not limited to, “nighttime shot,” “photo with a significant sky portion,” “picture with face(s) occupying much of the image,” “picture of a crowd,” “outdoor scene”, combinations thereof, and so forth. These visual features may be assigned to images automatically (e.g., with a classifier) or manually. Especially if visual features are assigned automatically, they may not be completely accurate, but they are still likely to be useful, at least to facilitate partitioning. These image features (e.g., image classifications) may be used as expansion queries 502 to be considered facet candidates. Thus, an image properties data source 308(3) may include multiple visual features representing different types of content that may be associated with image items to be searched.

In an example implementation, if an entry and/or image item in image properties data source 308(3) includes at least one of the original term(s) of original query 104, the associated concept or multiple concepts (e.g., tags, image feature classifications, etc.) may be ascertained to be an expansion query 502 or multiple expansion queries 502, respectively, that correspond to original query 104. An expansion query 502 that is ascertained from image properties data source 308(3) may therefore include one or more other terms that occur in the meta-data of an image item. Alternatively, an expansion query 502 that is ascertained from image properties data source 308(3) may therefore include one or more visual features that are associated with an image item. Thus, multiple expansion queries 502 may include at least a portion of the multiple image properties of image properties data source 308(3). These image properties may be combined with original term(s) of original query 104, depending on implementation.

FIG. 6 is a block diagram showing an example application 600 of multiple expansion queries 502 to an information collection 602 to determine numbers of search results 604 that are associated with the multiple expansion queries. As illustrated, example application 600 includes “m” expansion queries 502(1), 502(2) . . . 502(m) and “m” numbers of search results 604(1), 604(2) . . . 604(m). Although both expansion queries and numbers of search results are shown as having “m” elements, they may alternatively have different numbers of elements. For instance, one or more expansion queries 502 may not be applied to information collection 602.

In an example embodiment, multiple expansion queries 502 are applied to at least one information collection 602 to determine multiple numbers of search results 604. Thus, an expansion query 502 may be applied to information collection 602 to determine how many of the items of information collection 602 are considered relevant to the applied expansion query 502. In an example implementation, each respective expansion query 502 (that is to be considered in the analysis) is applied to information collection 602 to determine a respective number of search results 604 that are respectively associated with each applied expansion query 502. These expansion query 502/number of search results 604 pairs may be individually or jointly identified as facet candidates. Such pairs are described further herein below with particular reference to FIG. 7, according to particular example implementations.

In certain example embodiments, original query 104 is also applied to information collection 602 to determine the search results, and the number thereof, that are considered related to the original terms of the original query. Information collection 602 may include one or more separate, combined, etc. collections of information. Examples for information collection 602 include, but are not limited to, a public or private database or data repository generally, the information available over all or a portion of the WWW, the information available over all or a portion of the “Internet”, the information available over all or a portion of private network (e.g., a local area network or Ethernet), the information stored in all or a portion of a hard drive or other persistent storage medium, any combination thereof, and so forth, just to name a few examples.

The information collection 602 to which an expansion query 502 is applied may vary by implementation. For example, the information collection 602 to which an expansion query 502 is applied may comprise the same information collection 602 to which original query 104 is applied. In such an implementation, a particular expansion query 502 may include the original terms of original query 104 as well as the other terms derived from one or more data sources 308 (of FIGS. 3 and 5). For instance, with regard to the hypothetical “San Francisco” example, an expansion query 502 may comprise “San Francisco Golden Gate Bridge”. As an alternative example, the information collection 602 to which an expansion query 502 is applied may be an information collection that includes and focuses on those search results that are produced after original query 104 is applied to the overall targeted information collection. In such an implementation, an expansion query 502 may include the other terms derived from one or more data sources 308 while omitting those original terms of original query 104. For instance, with regard to the hypothetical “San Francisco” example, an expansion query 502 may be “Golden Gate Bridge”. For either example implementation or an alternative thereto, other elements (e.g., that are considered generally relevant or applicable) may be included in the information collection 602 to which an expansion query 502 is applied.

FIG. 7 is a block diagram showing an example generation 700 of a grouping of non-overlapping facets 706 from multiple facet candidates 702 that are associated with multiple expansion queries 502. As illustrated, example generation 700 includes at least one non-overlapping facet 704, a grouping of non-overlapping facets 706, a selection operation 708, and “m” pairs 710(1, 2 . . . m) of expansion queries 502 and their associated numbers of search results 604. It also includes “r” facet candidates 702(1) . . . 702(r), with “r” representing a positive integer.

In an example embodiment, an expansion query 502 and associated number of search results 604 may be considered an associated pair 710. A respective associated pair 710 individually or jointly comprises a facet candidate 702. A facet candidate 702 is therefore associated with a number of search results 604. Hence, at least initially, the integer values of “m” and “r” may be equal. To generate grouping 706 of non-overlapping facets, a facet candidate 702 may be selected via selection operation 708 to be designated a non-overlapping facet 704. Selection operation 708 may based, at least in part, on a number of search results 604 that are associated with the expansion queries 502.

Selection operation 708 may be repeated to establish grouping 706 of non-overlapping facets until a predetermined criterion is satisfied. It may be repeated, for example, until a desired predetermined number of non-overlapping facets 704 have been generated. Alternatively, selection operation 708 may be repeated until a timer expires, until a predetermined portion of the total search results that relate to the original query have been associated with a non-overlapping facet, until each identified facet candidate has been designated as a non-overlapping facet, and so forth.

At the stage of the procedure when multiple facet candidates 702 have been identified, many different refinements of the original query have been ascertained. A significant amount of overlap possibly exists in these expansion queries. However, that is acceptable at this stage inasmuch as the generation stage can be used to determine which of the refinements are most likely to be more helpful to a user.

For certain example embodiments, the facets are to partition a search space in a sensible and comprehensible, as well as a relatively complete, fashion. An original query can produce a large set of search results. An expansion query, or refinement of the original query, can produce a reduced set of these search results. In an example implementation, multiple facet candidates that are likely to cover an overall desirable portion of the original large set of search results (e.g., as much of the original large set of search results as is reasonably feasible) are to be generated.

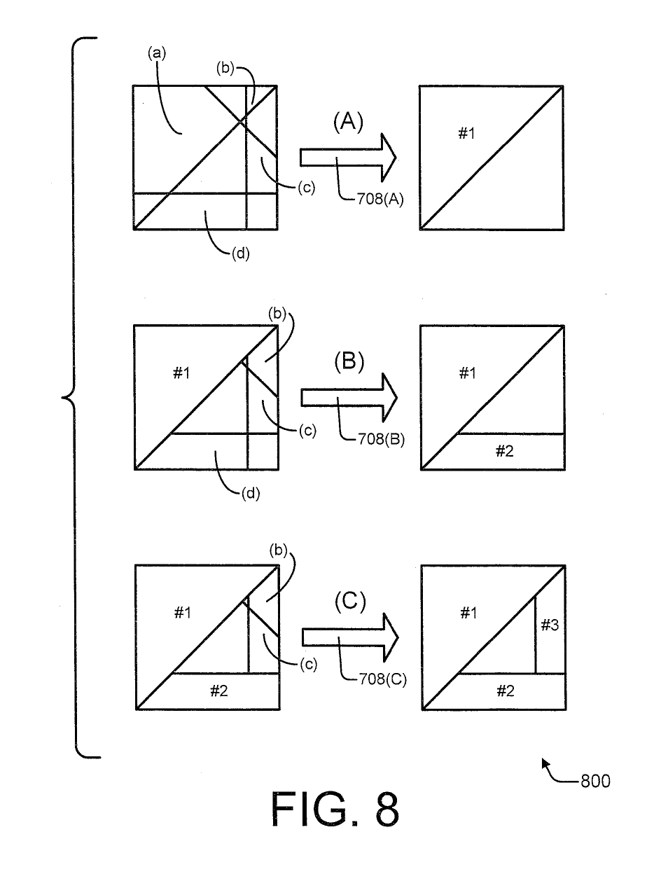

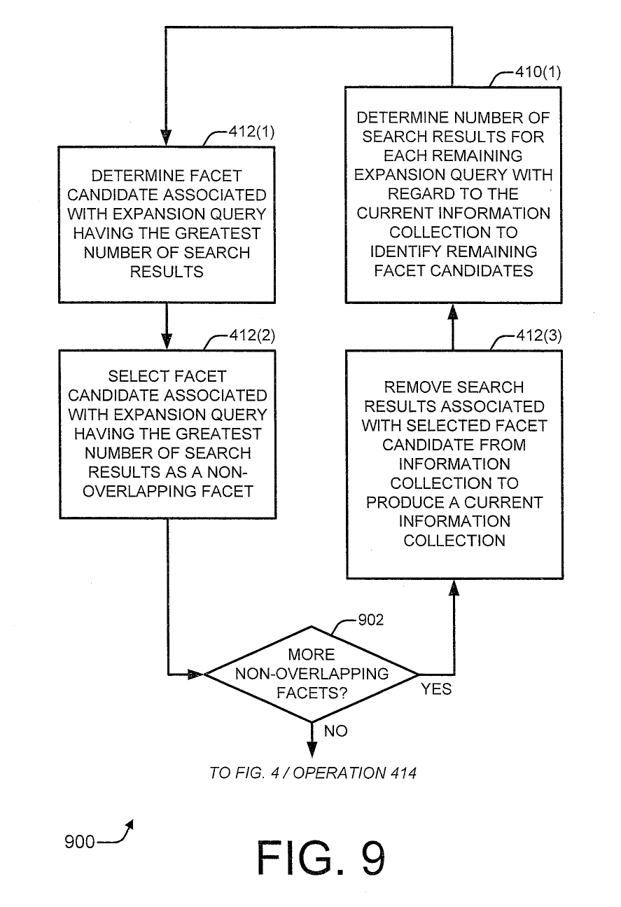

Thus, for certain example embodiments, this task may be analogous to the so-called “set covering” problem. In this case, a maximum set cover problem is pertinent to generating non-overlapping facets that provide insight into the overall set of related search results. One approach to this problem is the so-called greedy approximation to the maximum coverage algorithm (i.e., a greedy algorithm for implementing a maximum coverage scheme). This algorithm may be used to generate non-overlapping facets from identified facet candidates. For example, given a set, and a number of subsets, the subsets that cover as much of the set as possible are to be found. One approximation-based approach to finding these subsets is by selecting the largest subset during each iteration of an iterative scheme. Example embodiments that involve selecting a facet candidate that is associated with the greatest number of search results over multiple iterations are described herein below with particular reference to FIGS. 8 and 9.

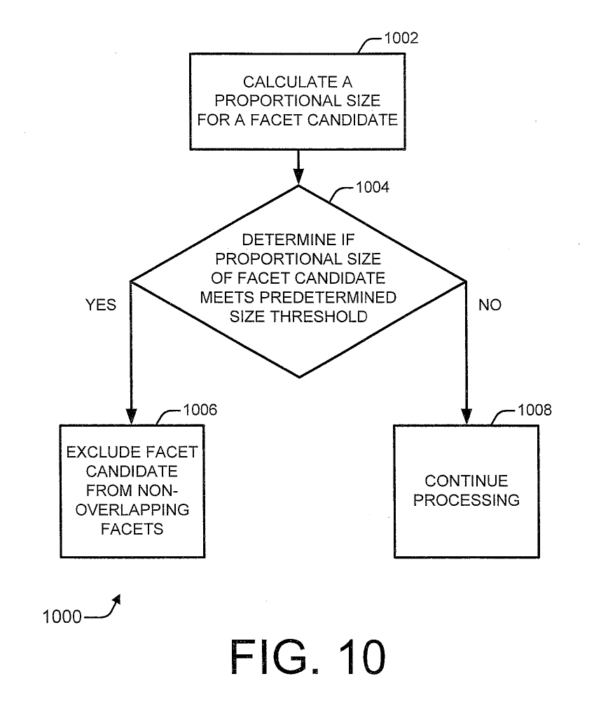

In example implementations, the largest subset may be rejected if it accounts for more than a certain percentage of the total current set. This can avoid choosing an actual or practical synonym for the total current set. Example embodiments that involve excluding a facet candidate that is associated with too great a number of search results are described herein below with particular reference to FIG. 10.

Other algorithms and/or approaches may alternatively be adopted for generating non-overlapping facets generally and/or for implementing an approach to addressing the “set cover” problem. For example, an algorithm that finds the best k substantially equal-sized facets may be employed. More specifically, multiple non-overlapping facets (e.g., for at least a majority of the non-overlapping facets of a grouping of non-overlapping facets) may be selected such that each non-overlapping facet of the multiple non-overlapping facets is associated with a substantially-similar number of search results. For instance, multiple non-overlapping facets may be generated so as to have within 5%-15% of the same number of search results.

FIG. 8 is graphical diagram 800 depicting an example generation of multiple non-overlapping facets. As illustrated, graphical diagram 800 is separated into three phases: (A), (B), and (C). The lower case letters (i.e., (a), (b), (c), and (d)) represent facet candidates. The numerals (i.e., #1, #2, and #3) represent non-overlapping facets.

For certain example embodiments, non-overlapping facets may be generated by selecting a facet candidate that is currently associated with a greatest number of search results. Graphical diagram 800 demonstrates an example implementation of this particular embodiment. Each of the six illustrated squares represents a group (e.g., set) of search results that are related (e.g., considered relevant) to an original query, including search results that are automatically included generally (if any). Consequently, in this graphical example, a facet candidate, which is associated with an expansion query and number of search results, may cover a portion of the square.

With reference to phase (A), facet candidate (a) is the larger triangle occupying the left half of the square, with the square corresponding to the set of search results that are related to the original query. Facet candidate (b) is the smaller triangle occupying the upper right portion of the square. Facet candidates (c) and (d) are the vertical and horizontal rectangles, respectively.

In phase (A), the facet candidate having the greatest number of search results is facet candidate (a). It is therefore selected as the first non-overlapping facet #1 in selection operation 708(A). To implement the non-overlapping aspect of the generated non-overlapping facets, the portion of the square that is occupied by the first non-overlapping facet #1 is removed from the analysis. The number of search results associated with each remaining expansion query/facet candidate is then determined again with regard to the reduced total number of remaining search results.

With reference to phase (B), those search results associated with non-overlapping facet #1 are removed from the analysis (e.g., by removing them from the current information collection 602 (of FIG. 6)). The remaining search result portions that are associated with the remaining facet candidates (b), (c), and (d) are as shown in the middle third of graphical diagram 800. For phase (B), the remaining facet candidate having the greatest number of search results is facet candidate (d). Facet candidate (d) is therefore selected in selection operation 708(B) as the second non-overlapping facet #2.

With reference to phase (C), those search results associated with non-overlapping facet #2 are also removed from the analysis. The remaining search result portions that are associated with the remaining facet candidates (b) and (c) are as shown in the bottom third of graphical diagram 800. For phase (C), the remaining facet candidate having the greatest number of search results is facet candidate (c). Facet candidate (c) is therefore selected in selection operation 708(C) as the third non-overlapping facet #3. The overall operation to generate grouping 706 of multiple non-overlapping facets 704 (both of FIG. 7) may be continued until at least one predetermined criterion is satisfied, as is described herein above. Although FIG. 8 illustrates an example generation of multiple non-overlapping facets, multiple substantially non-overlapping facets may be generated using similar and/or analogous principles.

FIG. 9 is a flow diagram 900 that illustrates an example method for generating multiple non-overlapping facets from identified facet candidates. As illustrated, flow diagram 900 includes five operations 410(1), 412(1), 412(2), 412(3), and 902. By way of example but not limitation, operation 410 (of FIG. 4) may be implemented at least partly by operation 410(1). Also by way of example but not limitation, operation 412 (of FIG. 4) may be implemented at least partly by operations 412(1), 412(2), and/or 412(3). After at least an initial operation 410, a number of search results have been determined for the ascertained expansion queries so as to identify facet candidates for consideration as non-overlapping facets.

In an example embodiment, at operation 412(1), a facet candidate that is associated with the expansion query having the greatest number of search results is determined. At operation 412(2), the facet candidate that is determined to be associated with the expansion query having the greatest number of search results is selected as a non-overlapping facet.

At operation 902, it is determined if more non-overlapping facets are to be generated. For example, it may be determined whether or not at least one predetermined criterion has been satisfied. If no more non-overlapping facets are to be generated, then the overall procedure may continue at operation 414 of FIG. 4. On the other hand, if “Yes” another non-overlapping facet is to be generated, then the procedure continues at operation 412(3).

At operation 412(3), the search results that are associated with the selected facet candidate are removed from the information collection to produce a current information collection. In other words, for an example implementation, the non-overlapping aspect of the generated non-overlapping facets may be achieved at least partially by removing search results that are associated with the selected facet candidate that is being designated a non-overlapping facet.

The search results removal may be performed in any of a number of different ways. For example, an information collection 602 (of FIG. 6) that was previously used to determine numbers of search results for the expansion queries may be reduced by the search results associated with the selected facet candidate. In other words, the contents of the current information collection may be iteratively and gradually reduced as each non-overlapping facet is designated. Alternatively, a new search may be performed with regard to the current information collection (which also comprises the “original” information collection in this implementation) with the original term(s) of the original query while excluding the term(s) associated with any selected facet candidate(s). For instance, a search may be run with the following query: {“San Francisco”—“Golden Gate Bridge”} to remove those search results that are associated with a “Golden Gate Bridge” facet candidate once it is designated a non-overlapping facet. Removing those search results that are associated with two selected facet candidates may thus be accomplished with the following example query: {“San Francisco”—“Golden Gate Bridge”—“Alcatraz”}.

At operation 410(1), a number of search results for remaining expansion queries with regard to the current information collection are determined to identify remaining facet candidates. For example, of the search results related to the original query that are not (yet) also associated with a non-overlapping facet, the remaining expansion queries are applied thereto to determine a number of search results for each of them. The method of flow diagram 900 may then be continued with operation 412(1).

FIG. 10 is a flow diagram 1000 that illustrates an example method for determining if a facet candidate is to be excluded from a grouping of non-overlapping facets based on a predetermined size threshold. As illustrated, flow diagram 1000 includes four operations 1002-1008. They may be implemented, for example, between operations 410 and 412 of FIG. 4 and/or between operations 410(1) and 412(1) of FIG. 9.

Sometimes, an expansion query that is applied to the original information collection and/or a current information collection may return an “overwhelming” number of search results. In other words, an expansion query may be associated with a disproportionally large number of search results. For example, an expansion query may be an actual or practical synonym for the original query (e.g., “Frisco” may be practically synonymous with “San Francisco”). To prevent such expansion queries from occupying as a facet too large a portion of the available non-overlapping search results space, a size threshold may be instituted.

In an example embodiment, at operation 1002, a proportional size for a facet candidate is calculated. For example, a proportional size of a given facet candidate may be based at least partly on a given number of search results associated with the given facet candidate and a total number of search results that are relevant from a current information collection. For instance, the percentage of search results associated with a facet candidate relative to the total (remaining) number of search results may be calculated.

At operation 1004, it is determined if the proportional size of the facet candidate meets a predetermined size threshold. For example, it may be determined if the percentage of search results meets (e.g., exceeds, equals or exceeds, etc.) a predetermined size threshold. The predetermined size threshold may be any, e.g., percentage threshold level. Example percentages include, but are not limited to, 20%, 25%, 33%, 50%, 60%, 70%, and so forth.

At operation 1006, a facet candidate that is determined to meet the predetermined size threshold is excluded from being designated a non-overlapping facet. For example, any facet candidate or candidates that is or are determined to have a proportional size that meets the predetermined size threshold may be omitted from the grouping of non-overlapping facets. The proportional size of the next largest facet candidate may then be calculated at operation 1002 and compared to the predetermined size threshold at operation 1004. On the other hand, if no facet candidate meets a predetermined size threshold (as determined at operation 1004), then the overall non-overlapping facet-generation procedure may be continued at operation 1008.

FIG. 11 is a block diagram 1100 of example devices 1102 that may be configured into special purpose computing devices that implement aspects of one or more of the embodiments that are described herein for generating non-overlapping facets for an original query. As illustrated, block diagram 1100 includes a first device 1102a and a second device 1102b, which may be operatively coupled together through one or more networks 1104. First device 1102a may correspond, for example, to first device 402a (of FIG. 4). Similarly, second device 1102b may correspond, for example, to second device 402b. Network 1104 may correspond to communication network 304 (of FIG. 3).

For certain example embodiments, first device 1102a and second device 1102b, as shown in FIG. 11, may be representative of any device, appliance, machine, combination thereof, etc. (or multiple ones thereof) that may be configurable to exchange data over network 1104. First device 1102a may be adapted to receive an input from a user. By way of example but not limitation, first device 1102a and/or second device 1102b may comprise: one or more computing devices and/or platforms, such as, e.g., a desktop computer, a laptop computer, a workstation, a server device, etc.; one or more personal computing or communication devices or appliances, such as, e.g., a personal digital assistant, a mobile “smart” phone, a mobile communication device, etc.; a computing system and/or associated service provider capability, such as, e.g., a database or data storage service provider/system, a network service provider/system, an Internet or intranet service provider/system, a portal and/or search engine service provider/system, a wireless communication service provider/system; any combination thereof; and so forth, just to name a few examples.

Network 1104, as shown in FIG. 11, is representative of one or more communication links, processes, and/or resources configurable to support the exchange of data between first device 1102a and second device 1102b. By way of example but not limitation, network 1104 may include wireless and/or wired communication links, telephone or telecommunications systems, data buses or channels, optical fibers, terrestrial or satellite resources, local area networks, wide area networks, intranets, the Internet, routers or switches, public or private networks, combinations thereof, and so forth, just to name a few examples.

All or part of the various devices and networks shown in block diagram 1100, as well as the other apparatuses and the other processes and methods that are further described herein, may be implemented using or otherwise include hardware, firmware, software, discrete/fixed logic circuitry, any combination thereof, and so forth. As illustrated, second device 1102b includes a communication interface 1108, one or more processing units 1110, an interconnection 1112, and at least one memory 1114. Memory 1114 includes primary memory 1114(1) and secondary memory 1114(2). Second device 1102b has access to at least one computer-readable medium 1106. Although not explicitly shown, first device 1102a may also include any of the components illustrated for second device 1102b.

Thus, by way of an example embodiment but not limitation, second device 1102b may include at least one processing unit 1110 that is operatively coupled to memory 1114 through interconnection 1112 (e.g., a bus, a fibre channel, a local area network, etc.). Processing unit 1110 is representative of one or more circuits configurable to perform at least a portion of a data computing procedure or process. By way of example but not limitation, processing unit 1110 may include one or more processors, controllers, microprocessors, microcontrollers, application specific integrated circuits (ASICs), digital signal processors (DSPs), programmable logic devices, field programmable gate arrays (FPGAs), any combination thereof, and so forth, just to name a few examples.

Memory 1114 is representative of any data storage mechanism. Memory 1114 may include, for example, a primary memory 1114(1) and/or a secondary memory 1114(2). Primary memory 1114(1) may include, for example, a random access memory, a read only memory, combinations thereof, and so forth. Although illustrated in this example as being separate from processing unit 1110, it should be understood that all or a part of primary memory 1114(1) may be provided within or otherwise co-located with/coupled directly to processing unit 1110 (e.g., as a cache or other tightly-coupled memory).

Secondary memory 1114(2) may include, for example, the same or similar types of memory as the primary memory and/or one or more data storage devices or systems. Data storage devices and systems may include, for example, a disk drive or array thereof, an optical disc drive, a tape drive, a solid state memory drive (e.g., flash memory, phase change memory, etc.), a storage area network (SAN), combinations thereof, and so forth. In certain implementations, secondary memory 1114(2) may be operatively receptive of, comprised partly of, and/or otherwise configurable to couple to computer-readable medium 1106. Computer-readable medium 1106 may include, for example, any medium that can store, carry, and/or make accessible data, code, and/or instructions for one or more of the devices in block diagram 1100.

Second device 1102b may also include, for example, communication interface 1108 that provides for or otherwise supports the operative coupling of second device 1102b to at least network 1104. By way of example but not limitation, communication interface 1108 may include a network interface device or card, a modem, a router, a switch, a transceiver, combinations thereof, and so forth.

Some portion(s) of this Detailed Description are presented in terms of algorithms or symbolic representations of operations on electrical digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by persons of ordinary skill in the signal processing, computational, or related arts to convey the substance of their work to others skilled in the art. An algorithm is here, and generally, considered to be a self-consistent sequence of operations or similar signal processing leading to a desired result. In this context, operations or processing involve physical manipulations of physical quantities. Typically, although not necessarily, such quantities may take the form of electrical (e.g., including electromagnetic) signals capable of being stored, transferred, combined, compared, or otherwise manipulated.

It has proven convenient at times, principally for reasons of common usage, to refer to such signals as bits, data, values, elements, symbols, characters, terms, numbers, numerals, or the like. It should be understood, however, that all of these or similar terms are to be associated with appropriate physical quantities and are merely convenient labels. Unless specifically stated otherwise, as is apparent from the preceding discussion, it is to be appreciated that throughout this Specification descriptions utilizing terms such as “processing,” “computing,” “calculating,” “selecting,” “removing,” “obtaining,” “ascertaining,” “determining,” “generating,” or the like refer to actions, operations, or processes of a specific apparatus, such as a special purpose computer or a similar special purpose electronic computing device. In the context of this Specification, therefore, a special purpose computer or a similar special purpose electronic computing device is capable of using at least one processing unit to manipulate or transform signals, which are typically represented as physical electronic/electrical or magnetic quantities within memories, registers, or other information storage devices; transmission devices; display devices; etc. of the special purpose computer or similar special purpose electronic computing device.

While certain exemplary techniques have been described and shown herein using various methods, apparatuses, and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter may also include all implementations falling within the scope of the appended claims, and equivalents thereof.

What is claimed is:

1. A method comprising:
executing instructions, by a special purpose computing device, to direct the special purpose computing device to:
obtain first electrical digital signals representative of an original query input by a user;
ascertain a plurality of expansion queries corresponding to said original query using one or more data sources;
determine a number of search results associated with at least a portion of said plurality of expansion queries with regard to at least one information collection to identify a plurality of facet candidates; and
generate a plurality of substantially non-overlapping facets for said original query from said plurality of facet candidates based, at least in part, on said number of search results associated with the at least a portion of said plurality of expansion queries.

2. The method of claim 1, wherein the instructions, in response to being executed by the special purpose computing device, further direct the special purpose computing device to initiate transmission of second electrical digital signals, which are representative of said plurality of substantially non-overlapping facets to a user device of the user, through an electronic communication network.

3. The method of claim 2, wherein the instructions, in response to being executed by the special purpose computing device, further direct the special purpose computing device to precipitate presentation of a visual display on the user device based at least partly on said second electrical digital signals, the visual display capable of communicating to the user said plurality of substantially non-overlapping facets.

4. The method of claim 1, wherein the instructions, in response to being executed by the special purpose computing device, further direct the special purpose computing device to ascertain said plurality of expansion queries corresponding to said original query using a data source that comprises a query log, said query log including a plurality of queries that have been previously input by one or more users.

5. The method of claim 1, wherein the instructions, in response to being executed by the special purpose computing device, further direct the special purpose computing device to ascertain said plurality of expansion queries corresponding to said original query using a data source that comprises a related concepts database, said related concepts database including a plurality of entries having at least one entry that associates said original query with one or more other terms.

6. The method of claim 1, wherein the instructions, in response to being executed by the special purpose computing device, further direct the special purpose computing device to ascertain said plurality of expansion queries corresponding to said original query using a data source that comprises a plurality of image properties.

7. The method of claim 1, wherein the instructions, in response to being executed by the special purpose computing device, further direct the special purpose computing device to generate said plurality of substantially non-overlapping facets for said original query from said plurality of facet candidates using a greedy approximation for a maximum coverage algorithm.

8. The method of claim 1, wherein the instructions, in response to being executed by the special purpose computing device, further direct the special purpose computing device to generate said plurality of substantially non-overlapping facets for said original query from said plurality of facet candidates such that each substantially non-overlapping facet for at least a majority of the substantially non-overlapping facets of said plurality of substantially non-overlapping facets is associated with a substantially-similar number of search results for the expansion query that is associated therewith.

9. The method of claim 1, wherein the instructions, in response to being executed by the special purpose computing device, further direct the special purpose computing device to:
determine if a proportional size of a given facet candidate of said plurality of facet candidates meets a predetermined size threshold; and
if said proportional size of said given facet candidate is determined to meet said predetermined size threshold, exclude said given facet candidate from said plurality of substantially non-overlapping facets.

10. The method of claim 9, wherein the instructions, in response to being executed by the special purpose computing device, further direct the special purpose computing device to calculate said proportional size of said given facet candidate based at least partly on a given number of search results associated with said given facet candidate and a total number of search results that are relevant from a current information collection.

11. The method of claim 1, wherein the instructions, in response to being executed by the special purpose computing device, further direct the special purpose computing device to:
determine, from said plurality of facet candidates, a particular facet candidate that is associated with a particular expansion query that is associated with a greatest number of search results; and
select said particular facet candidate that is associated with said particular expansion query that is associated with said greatest number of search results as a substantially non-overlapping facet for said plurality of substantially non-overlapping facets.

12. The method of claim 11, wherein the instructions, in response to being executed by the special purpose computing device, further direct the special purpose computing device to:
remove search results associated with said particular facet candidate from said at least one information collection to produce a current information collection; and
determine a number of search results associated with remaining ones of the at least a portion of said plurality of expansion queries with regard to said current information collection to identify a plurality of remaining facet candidates.

13. A system comprising:
a communication interface adapted to at least receive digital signals through a communication network; and
a special purpose computing device programmed with instructions to:
obtain first electrical digital signals representative of an original query input by a user;
ascertain a plurality of expansion queries corresponding to said original query using one or more data sources;
determine a number of search results associated with at least a portion of said plurality of expansion queries with regard to at least one information collection to identify a plurality of facet candidates; and
generate a plurality of substantially non-overlapping facets for said original query from said plurality of facet candidates based, at least in part, on said number of search results associated with the at least a portion of said plurality of expansion queries.

14. The system of claim 13, wherein said special purpose computing device is further programmed with instructions to ascertain said plurality of expansion queries corresponding to said original query using said one or more data sources wherein a data source of said one or more data sources comprises a plurality of visual features representing different types of content that may be associated with image items to be searched.

15. The system of claim 13, wherein said special purpose computing device is further programmed with instructions to determine said number of search results associated with the at least a portion of said plurality of expansion queries with regard to said at least one information collection to identify said plurality of facet candidates wherein said at least one information collection comprises a plurality of image items, at least a portion of said plurality of image items associated with one or more tag words and at least one visual feature.

16. The system of claim 13, wherein said special purpose computing device is further programmed with instructions to exclude from said plurality of substantially non-overlapping facets those facet candidates of the plurality of facet candidates that meet a predetermined size threshold.

17. The system of claim 13, wherein said special purpose computing device is further programmed with instructions to select those facet candidates of the plurality of facet candidates that have a greatest number of search results associated therewith to be substantially non-overlapping facets of said plurality of substantially non-overlapping facets.

18. The system of claim 13, wherein said special purpose computing device is further programmed with instructions to remove those search results that are associated with any generated substantially non-overlapping facets of said plurality of substantially non-overlapping facets from the at least one information collection to produce a current information collection.

19. An article comprising:
a storage medium comprising machine readable instructions stored thereon which, in response to being executed by a special purpose computing device, are adapted to direct the special purpose computing device to:
obtain first electrical digital signals representative of an original query input by a user;
ascertain a plurality of expansion queries corresponding to said original query using one or more data sources;
determine a number of search results associated with at least a portion of said plurality of expansion queries with regard to at least one information collection to identify a plurality of facet candidates; and
generate a plurality of substantially non-overlapping facets for said original query from said plurality of facet candidates based, at least in part, on said number of search results associated with the at least a portion of said plurality of expansion queries.

20. The article of claim 19, wherein said machine readable instructions, in response to being executed by the special purpose computing device, are adapted to direct the special purpose computing device to:
determine, from said plurality of facet candidates, a particular facet candidate that is associated with a particular expansion query that is associated with a greatest number of search results;
select said particular facet candidate that is associated with said particular expansion query that is associated with said greatest number of search results as a substantially non-overlapping facet for said plurality of substantially non-overlapping facets;
determine if a proportional size of a given facet candidate of said plurality of facet candidates meets a predetermined size threshold; and
if said proportional size of said given facet candidate is determined to meet said predetermined size threshold, exclude said given facet candidate from said plurality of substantially non-overlapping facets.
